(19) United States
(12) Patent Application Publication
(10) Pub. No.: US 2022/0186559 A1
(43) Pub. Date: Jun. 16, 2022

(54) Ladder Stabilizer

(71) Applicant: Ladder Frog, LLC, Milford, OH (US)

(72) Inventors: Scott Hardoerfer, Milford, OH (US); Thomas A. Volz, Cincinnati, OH (US)

(73) Assignee: Ladder Frog, LLC, Milford, OH (US)

(21) Appl. No.: 17/546,601

(22) Filed: Dec. 9, 2021

Related U.S. Application Data
(63) Continuation of application No. 29/817,234, filed on Nov. 30, 2021.
(60) Provisional application No. 63/123,654, filed on Dec. 10, 2020.

(51) Int. Cl. E06C 7/48; E06C 7/06

(52) U.S. Cl. CPC E06C 7/486; E06C 7/488; E06C 7/06

(57) ABSTRACT

A ladder stabilizer removably mounts to one of the two spaced rails of a conventional ladder, and a mirror image stabilizer preferably mounts to the other rail. The stabilizer is of unitary construction, preferably injection molded from thermoplastic material, and includes a longitudinal member with an open channel along one longitudinal surface, the channel bounded by opposing longitudinal flanges. The member is sized and shaped and of sufficient flexibility to removably mount to the rail at any desired vertical position, and is relatively non-slidable with respect thereto once mounted. An opposite longitudinal surface of the member includes a plurality of step-like serrations. With one stabilizer mounted to each of the two ladder rails, and the ladder leaned against a structure for conventional use, the step-like serrations reduce the risk of movement of the ladder relative to the structure, and therefore promote safe use of the ladder. Also, the composition of the stabilizer protects the structure from any adverse effects.

### RELATED APPLICATION

This application claims priority to U.S. Provisional Patent Application Ser. No. 63/123,654, entitled “Ladder Gutter & Architectural Protective Device,” and filed on Dec. 10, 2020, and also to U.S. Design patent application Ser. No. 29/817,234 entitled “Ladder Stabilizer,” and filed on Nov. 30, 2021, each of which is expressly incorporated herein, in its entirety.

### FIELD OF THE INVENTION

The present invention relates to a device that stabilizes a conventional ladder when in use, while also protecting the corresponding structure that supports the ladder

### BACKGROUND OF THE INVENTION

Ladders are well known, and regularly used to enable a person to increase his or her vertical reach or vertical level. Typically, the user leans the two spaced side rails of the ladder against a structure, often a building, for example the gutter of a building, then checks to make sure that the ladder is stable, and then proceeds up the steps, or rungs of the ladder, as needed. Most ladders are of relatively lightweight, to enhance portability.

One type of conventional ladder, often referred to as an extension ladder, includes two sections that are slidable longitudinally relative to each other. The bottom or ground supported section is often referred to as the base section, while the upper or extended section is often referred to as the fly section. An extension ladder enables the user to reach higher vertically, or to get to a higher vertical level.

With a conventional ladder, whether or not an extension ladder, when the user leans the side rails against the support structure, often the gutter of a building, it is important to make sure that the rails equally engage the structure. This can sometimes be difficult to do because of the circumstances. For example, if the ground that supports the ladder is not level, either relative to the forward/rear direction or the side-to-side direction, then the engagement forces of the two opposing rails may differ. This could cause the ladder to move relative to the building, i.e., to slide laterally, which can be dangerous for the user. Further, if the ladder use is outdoors, and the ground is wet or even damp, slipping of the bottom of the ladder could further increase the risks for the user.

One possible solution to this problem is to somehow clamp, or temporarily secure, the ladder rails to the structure, so as to prevent any movement of the ladder relative to the structure. However, with this approach, until the ladder is in place against the structure, it may not be exactly clear where such clamps should be placed on the ladder rails, to best engage the structure while in use. Also, this approach would require the user to secure the clamp while already on the ladder, to some extent defeating the purpose. Further, with this scenario the user would need to carry the clamping structures along with the ladder, which presents an inconvenience. Still further, such clamps, or other attachment devices, could potentially damage the building. For example, the shape of a gutter could become distorted and/or abraded by the attachment of such a clamp.

It is an object of the present invention to enhance the safety of a conventional ladder, and to do so in a manner that overcomes problems associated with prior options, and also in a manner that is relatively convenient and inexpensive, and which poses virtually no risk of adversely affecting the engaged building structure.

### SUMMARY OF THE INVENTION

The present invention achieves these above-stated objects via a ladder stabilizer that removably mounts in non-slidable fashion to one of the two spaced rails of a ladder, with a mirror image stabilizer similarly mounted to the other rail, wherein each stabilizer includes an external surface with a series of serrations or steps that help to hold the ladder in place relative to the structure. Engagement of these stabilizer steps by the structure that the ladder is leaning on enhances the stability of the ladder when in use, by reducing the potential for the ladder to move relative to the structure, thereby improving the safety of the ladder.

According to a preferred embodiment of the invention, a ladder stabilizer comprises a unitary structure molded of polymeric material, preferably an injection molded thermoplastic with a Durometer of 65A. This unitary structure includes a longitudinal member having a first longitudinal outer surface with a plurality of step-like serrations, for engaging the building structure, and a second, opposite longitudinal internal surface with a longitudinal channel along the length thereof, the channel defined by opposing longitudinal flanges. The channel and the flanges are sized and shaped, and the composition of the member is such that, the stabilizer flexes to readily and removably mount to the corresponding ladder rail in a non-slidable manner. The shape and composition accommodate a relatively low price for this stabilizer, and relative ease in shipping to a user, and thereafter transporting by the user.

In use, a person mounts the stabilizers to the ladder rails at positions that are close to where the ladder will engage the structure. Because the stabilizer is elongated, preferably with a length of about one foot, these mounting positions do not need to be exact. They need only to span the part of the rail that will contact the structure. The non-slidable relationship of the mounted stabilizer enables both of the stabilizers to be transported with the ladder, if desired, when the ladder is not in use. This feature eliminates the need for separate storage of the stabilizers when not in use. Also, when a user wishes to remove the stabilizer, the flanges are flexed away from each other, and the member pulled away from the rail.

Further, the construction of the stabilizer is such that its engagement with the structure, most commonly a gutter, will not cause any adverse affects to the structure. Rather, the pliant nature of the stabilizer composition eliminates concerns about abrasion or other damage to the structure.

Those skilled in the art will better appreciate and understand the present invention after reviewing and considering the accompanying drawings. This specification first describes the drawings briefly, immediately below, and then describes them in more detail.

### BRIEF DESCRIPTION OF THE DRAWINGS

FIG. 1 is a top left perspective view that shows a preferred embodiment of the present invention while in use, with a pair of ladder stabilizers mounted on two spaced rails of a ladder that engages a gutter.

FIG. 2 is another top left perspective view, similar to FIG. 1, but in closeup, or enlarged view.

FIG. 3 is a side view of the structure shown in FIGS. 1 and 2, showing one ladder stabilizer of the present invention mounted on a ladder rail and engaging the gutter of a building.

FIG. 4 is a cross sectional view taken along lines 3-3 of FIG. 3.

FIG. 5 is a front right perspective view of the ladder stabilizer shown in FIGS. 1-4.

FIG. 6 is a rear left perspective view thereof.

### DETAILED DESCRIPTION OF THE INVENTION

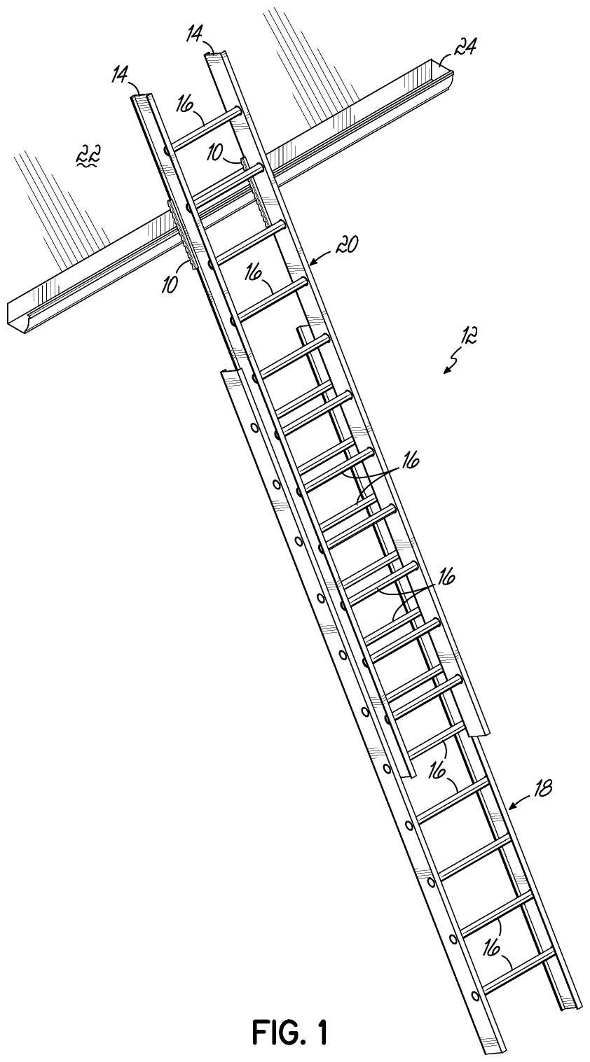

FIG. 1 shows a pair of ladder stabilizers 10 in use, according to a preferred embodiment of the invention. More particularly, the ladder stabilizers 10 are mounted to a ladder 12 that includes a pair of spaced rails, or legs, 14, and a plurality of steps, or rungs, 16, that span and connect the rails 14. The ladder 12 in FIG. 1 is an extension ladder 12, and it includes a base section 18 and a fly, or extension, section 20. Nonetheless, the present invention is equally applicable to ladders that are not extension ladders. Further, in FIG. 1 the ladder leans against, or engages, a structure 22, which in this case is a gutter 24.

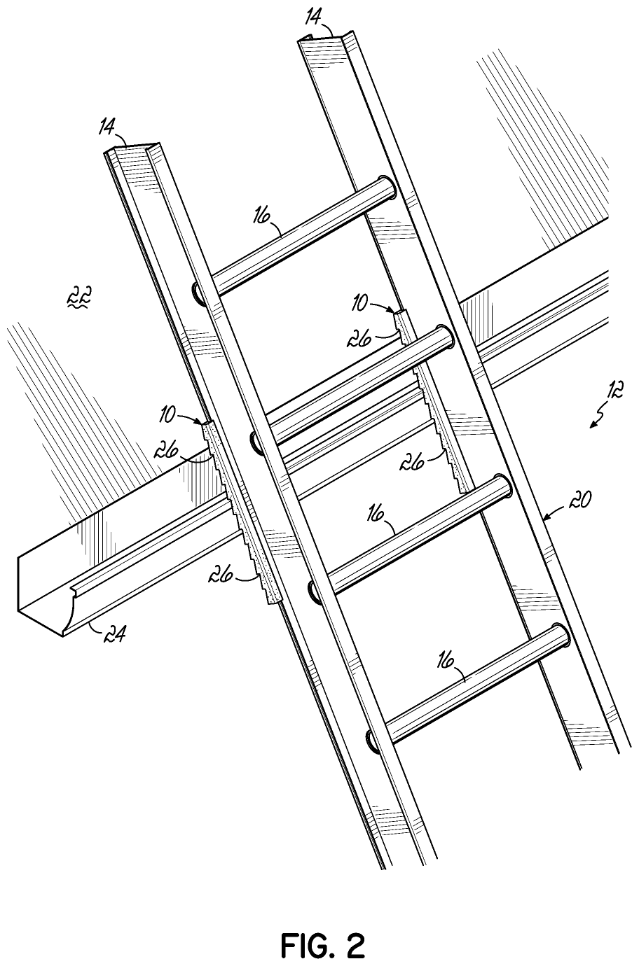

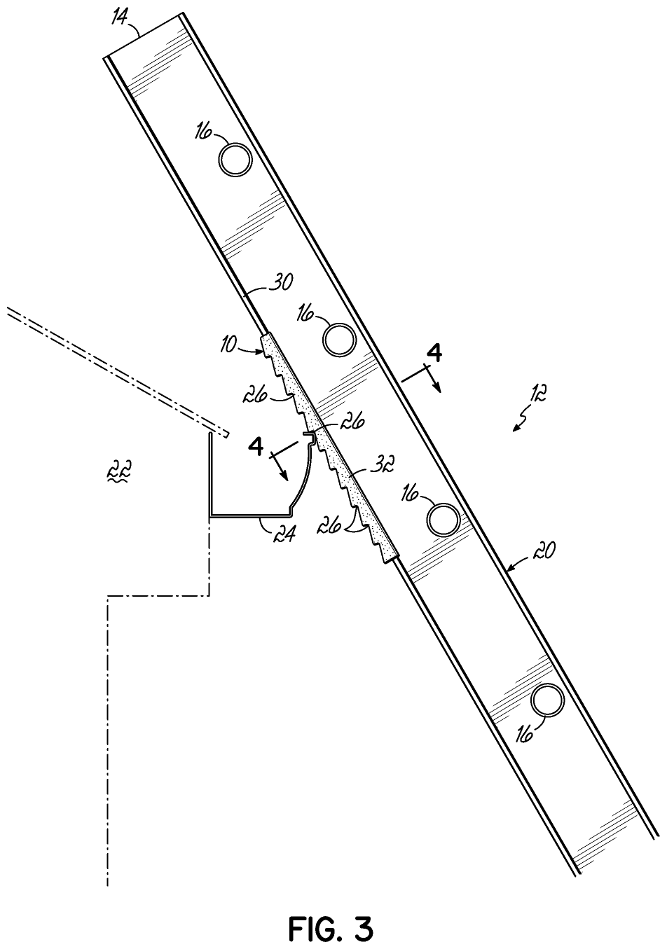

FIG. 2, an enlarged view, shows the two stabilizers 10 in more detail, with each one being an elongated, or longitudinal member, and having a plurality of steps, or step-like serrations 26, along a first longitudinal external surface thereof. The side view of FIG. 3 more clearly shows the steps 26 of the stabilizer 10 relative to the gutter 24. The steps 26 are preferably squared off to optimally engage the gutter 24, but the step angle could differ, if desired. For each stabilizer 10, a second longitudinal internal surface thereof removably secures to one rail 14 of the ladder 12.

The stabilizer 10 is preferably of unitary construction, made of polymeric material by injection molding. Applicant has successfully used a thermoplastic vulcanate, particularly Sarlink 6165N, with a Durometer of 65A, although other materials could be suitable. The stabilizer 10 is relatively flexible and/or pliable, so as to flex sufficiently for mounting on the rail 14, but also sticky, or tacky, enough so as not slip along the rail 14 once in place. Further, this composition of the stabilizer 10 provides a sufficient degree of frictional engagement, or stickiness, between the ladder 12 and the gutter 24, so as to prevent any relative sliding movement. Still further, the stabilizer 10 is sufficiently pliable such that engagement with the gutter 24 does not scrape or cause any adverse effects.

With a plurality of steps 26 on the external surface of the stabilizer 10, and the stabilizers 10 being elongated, there is no need for the user to mount the two stabilizers 10 in the exact same vertical positions on the spaced rails 14 of the ladder 12. Rather, each of the external steps 26 provides the same engagement capability relative to the gutter 24. In fact, if the bottom of the ladder 12 is supported on an uneven surface, i.e., such as unlevel ground, then even if the stabilizers 10 were located in the same vertical rail positions the engagement points with the gutter 26 would differ. In this respect the present invention inherently accommodates some level of unevenness of the support surface on which the ladder 12 is supported during use.

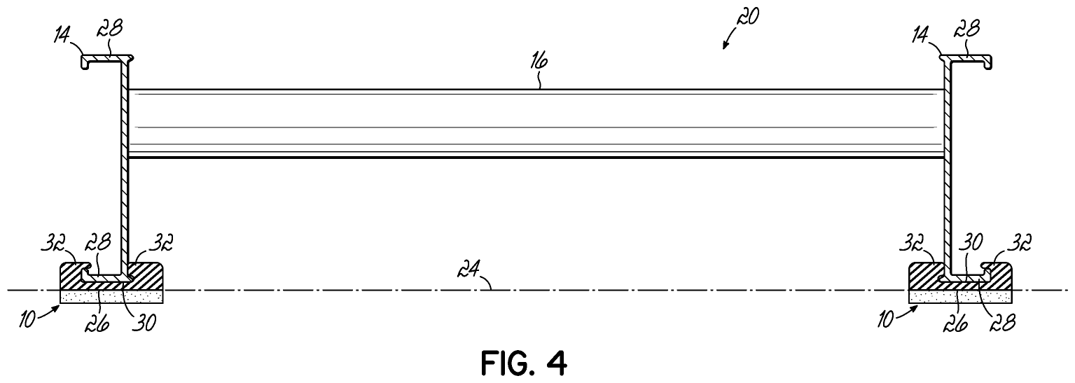

FIG. 4 shows an end view of the rails 14 of the ladder 12, and particularly the rail ends, or elements, 28 located at opposite ends of each rail 14. These rail ends 28 provide greater structural rigidity for the ladder 12. In the context of the present invention, the rail ends 28 are shown enclosed or partially surrounded by a channel 32 formed in the second, internal surface of the stabilizer 10, with the channel 32 partially defined by a pair of opposing flanges 32. Preferably, the stabilizer 10 flexes so as to enable the flanges 32 to surround the rail ends 28 and to thereby locate most of the transverse cross section of the rail 14 within the channel 30. The size of the stabilizer 10 is such that mounting in this manner provides a snug, non-slidable fit. In fact, the fit may be sufficiently snug so as to enable the user to carry the stabilizers 10 with the ladder 12 when not in use. FIG. 4 shows that, when in use, this structural relationship exists at both of the two side rails 14 of the ladder 12. Those skilled in the art will understand, particularly from FIG. 4, that the transverse cross sectional dimension of the stabilizer 10 could be varied to accommodate a rail 14 of different size and shape. Further, generally, the internal transverse cross sectional shape of the stabilizer 10, i.e., the part defined by the interior of the flanges 32 and the channel 30, remains the same along the length thereof.

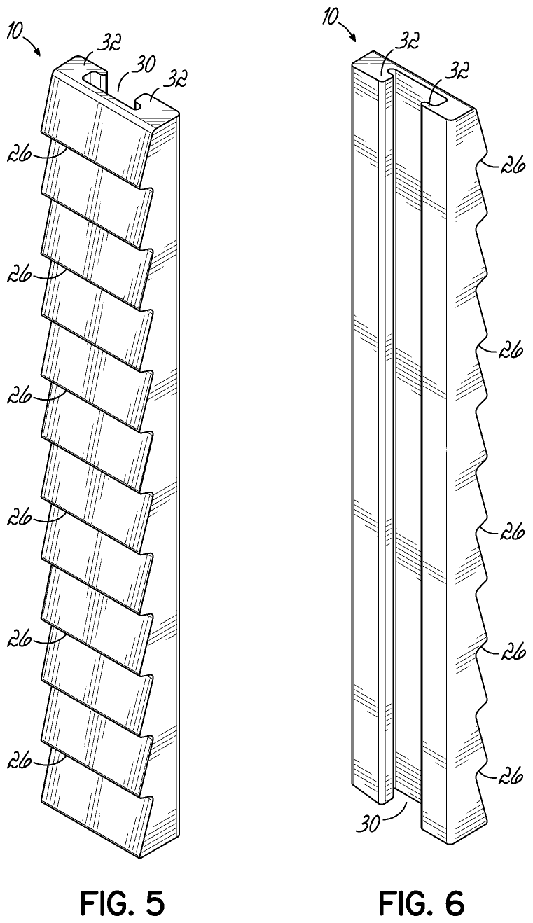

FIGS. 5 and 6 show perspective view of the stabilizer 10, from the front right and from the rear left, respectively. These views better show the relationship between the step-like serrations on the external or first engagement surface of the longitudinal member 10, and the channel 30 and the opposing flanges 32 on the opposite second, internal mounting surface thereof. As shown, the stabilizer 10 has a length of about one foot, or 12 inches. Applicant has found this particular dimension to be fairly convenient. For example, it is small enough and is of sufficiently minimal weight to be made and shipped relatively easily. But at the same time, this length is of sufficient dimension to enable the user to mount a pair of stabilizers 10 to the spaced rails 14 of a ladder 12 without having to mount them in exactly the same relative vertical position. Regardless, those skilled in the art will appreciate that this length could be varied so as to suit various preferences. In other words, the length could be longer, or shorter, as desired.

Also, the construction of the stabilizer 10, i.e., the shape, may be varied to achieve different specific needs. This is also true with respect to the composition, or even the structure thereof. More particularly, applicant has found it advantageous to make the stabilizer 10 as a unitary structure, by injection molding a thermoplastic to result in a stabilizer with a Durometer of 65A, and which is sufficiently flexible to mount to a rail 14 and stay mounted in a non-slidable manner. It also results in a product that has a reasonable amount of structural rigidity to remain secured to the structure 22, in a non-slip or frictional relationship. The stabilizer 10 preferably is also not hard or abrasive, so as to not adversely affect the structure 22 as a result of engagement with the ladder 12 during use, and even perhaps as a result of some intentional lateral movement with respect thereto, as for example when a user may be changing the position of the ladder 12 relative to the structure 22.

Persons skilled in the art will understand that this specification, via the descriptions in the text and the views of the accompanying Figures, discloses a presently preferred embodiment of the invention. Those same persons will also understand that these disclosed details are intended to be exemplary, not limiting, and that the accompanying claims define the scope of the invention.

We claim:

1. A ladder stabilizer for stabilizing one of the rails of a ladder as the ladder leans against a structure, comprising:
a longitudinal member having two opposing longitudinal surfaces;
a longitudinal channel formed along one of the longitudinal surfaces, the channel defined by opposing longitudinal flanges, the longitudinal member and the opposing longitudinal flanges being adapted to flex so as to enable the longitudinal member to removably mount in a non-slidable relationship to one of the rails of the ladder at a desired vertical position when in use; and
a plurality of step-like serrations located along the other of the longitudinal surfaces of the longitudinal member, wherein when in use at least one of the step-like serrations engages the structure so as to minimize the occurrence of movement of the corresponding rail relative to the structure.

2. The invention of claim 1 and further comprising:
a second longitudinal member, the second longitudinal member being a mirror image of the first and mounted to the other of the rails of the ladder at about the same vertical position, whereby the two longitudinal members mounted to the two rails of the ladder both engage the structure, thereby to further minimize the occurrence of movement of the ladder relative to the structure.

3. The ladder stabilizer of claim 1 wherein the longitudinal member is of unitary construction and comprises a thermoplastic material.

4. The ladder stabilizer of claim 3 wherein the longitudinal member is made by molding.

5. The ladder stabilizer of claim 1 wherein the longitudinal member has a relatively uniform transverse cross-sectional shape along its entire length.

6. The ladder stabilizer of claim 1 wherein the longitudinal member has a Durometer of 65A.

7. A method for stabilizing a ladder against a structure, the ladder including a pair of spaced rails, comprising:
mounting to each of the rails, at a position proximate the likely location of engagement of the rail with the structure, a longitudinal member, each of the two longitudinal members including a longitudinal channel defined by opposing flanges, wherein the longitudinal channel and the opposing flanges are sufficiently flexible so as to partially surround the respective rail in a relatively tight fit, thereby to removably mount the longitudinal member to the respective rail in a manner that is non-slidable relative thereto;
whereby each of the longitudinal members, on a surface opposite the longitudinal channel, includes a plurality of step-like serrations extending along the longitudinal member; and
locating the ladder, and more particularly the longitudinal members mounted thereto, in engagement with the structure so that for each rail of the ladder the structure engages at least one of the serrations in the corresponding plurality of step-like serrations, thereby to hold the position of the ladder relative to the structure so as to minimize the risk of the ladder moving relative thereto during use, the plurality of step-like serrations also being sufficiently pliable so as to minimize any adverse effects on the structure as a result of the engagement by the ladder.

8. The method of claim 7 wherein each of the side rails has a pair of opposing rail ends, and the corresponding flanges of the longitudinal member are sized to extend around the opposing rail ends.

9. The method of claim 7 wherein each of the longitudinal members is of unitary construction and has a Durometer of 65A.

10. A method of forming a ladder stabilizer, comprising:
molding a thermoplastic material to create an elongated member of unitary construction having a Durometer of 65A, the elongated member having two opposing longitudinal surfaces, one of the longitudinal surfaces having a plurality of step-like serrations, and another of the longitudinal surfaces having an elongated channel extending along the length thereof, the longitudinal channel defined by opposing longitudinal flanges; and
the elongated member adapted to flex to enable a rail of a ladder to be partially enclosed by the longitudinal channel and the longitudinal flanges, wherein, when mounted to the rail in this manner, the oppositely directed plurality of step-like serrations is engageable against a structure where the ladder is used.

11. The method of claim 10 wherein the molding is injection molding, and the elongated member is about one foot long.

12. The method of claim 10 wherein the internal transverse cross sectional shape of the member remains uniform along the length thereof.

13. The method of claim 10 wherein the thermoplastic material is Sarlink TPV 6165N.
